(19) United States
(12) Patent Application Publication
(10) Pub. No.: US 2013/0020442 A1
(43) Pub. Date: Jan. 24, 2013

(54) STATIC KITE OF SEAMLESS ARTICULATED ASSEMBLY

(71) Applicant: Alejandro Prieto Estebanez, Gijon (ES)

(72) Inventor: Alejandro Prieto Estebanez, Gijon (ES)

(73) Assignee: EOLO SPORT INDUSTRIAS, S.A., Gijon (ES)

(21) Appl. No.: 13/187,231

(22) Filed: Jul. 20, 2011

(51) Int. Cl. B64C 31/06

(52) U.S. Cl. 244/153 R

(57) ABSTRACT

A static kite of seamless articulated assembly is formed from a laminar body of plastic, cloth or similar material which can be folded and extended by a rod structure which includes a central longitudinal rod and two front-side rods, these being attached by one of their ends on a central connector assembled in a sliding manner on the central longitudinal rod. The free ends of these side rods being anchored in respective side connectors by arms, where the side rods and a shaft which integrally connects the side connector to the arm are housed. The ends of the central longitudinal rods are anchored in respective fixed vertical connectors containing a cavity where the central rod is housed, both side and vertical connectors being pre-attached to the kite by rivets integrally connecting them to the sail preventing rotating or twisting.

### OBJECT OF THE INVENTION

The present invention relates to a static kite of seamless articulated assembly being able to have any geometric configuration and made from a partially flat surface as the sail of the kite and an inner either plastic or cloth structure which tenses said surface, having the particularity that the structure is made up of three simple rods in combination with a sliding connector sliding on one of them

The object of the invention is to obtain a kite of those known as static kites, the framework of which has structural features allowing the folding and extending thereof in an extremely fast and simple manner specifically with a single movement of the hand.

### BACKGROUND OF THE INVENTION

As is known, any kite, particularly “static” type kites, are assembled and disassembled to reduce the space they take up when not in use such that the framework or structure is formed by means of several rods which are fixed at their ends in connecting points between them and the laminar body of the kite such that the mentioned final structure or framework is a result of the connection between at least four different manually connected points.

The type of connection attaching the rods to the cloth of the kite are simple pockets stitched to the sail or cloth receiving the rods therein, but in any case the assembly and disassembly operations are slow and laborious.

### SUMMARY OF THE INVENTION

The static kite of seamless articulated assembly proposed by the invention fully and satisfactorily solves the problems set forth above such that based on features which will be disclosed throughout the present description, it is possible to fold and extend in a single, extremely fast and simple manual operation as already mentioned in the object of the invention section.

More specifically the structure of the kite is made by means of a longitudinal rod and two side rods in correspondence with the front area of the kite, which side rods are curved and attached by means of an articulation to a central connector assembled in a sliding manner on the longitudinal rod. The free ends of the side rods are housed in a fixed manner on free moving arms by means of an axial through hole to the side connectors by means of a bolt with a harpoon shaped tip to fix the said arms to the side connector. Said side connectors will be fixed to the sail or kite through a rivet, while the ends of the longitudinal rod are housed in flat connectors fixed to the sail by means of rivets and they are housed in a fixed manner in blind cavities.

The side rods are attached to the central connector by interpositioning respective articulated arms in respective shafts provided in the central connector, one on each of the sides thereof, and the arms of which have an axial blind hole in which the end of the respective rod is precisely housed, while in the extended position of the kite, the mentioned arms logically stay extended and located in laterally arranged channels in the connector itself, the latter has a hole for its assembly and sliding passage through the longitudinal rod.

Based on these features, the forwards or backwards movement of the central connector with respect to the longitudinal rod allows folding/extending the kite as a whole as if it were a flat umbrella with the particularity that said connector allows keeping the static kite stable when it is extended.

A part fixed by means of an adhesive has been also been provided on the longitudinal rod close to the front end, the purpose of which is for blocking the central connector itself with the arms articulated to same in the extended position of the assembly.

Finally, the kite will be completed with the corresponding flight line or bridle in relation to the longitudinal rod through the ends of said bridle, allowing and facilitating the flight of the kite in question.

### BRIEF DESCRIPTION OF THE DRAWINGS

To complement the description provided below and for the purpose of aiding to better understand the features of the invention according to a preferred practical embodiment thereof, a set of drawings is attached as an integral part of said description in which the following has been depicted with an illustrative and non-limiting character:

FIG. 1 shows a front view of the static kite of the invention in the extended position.

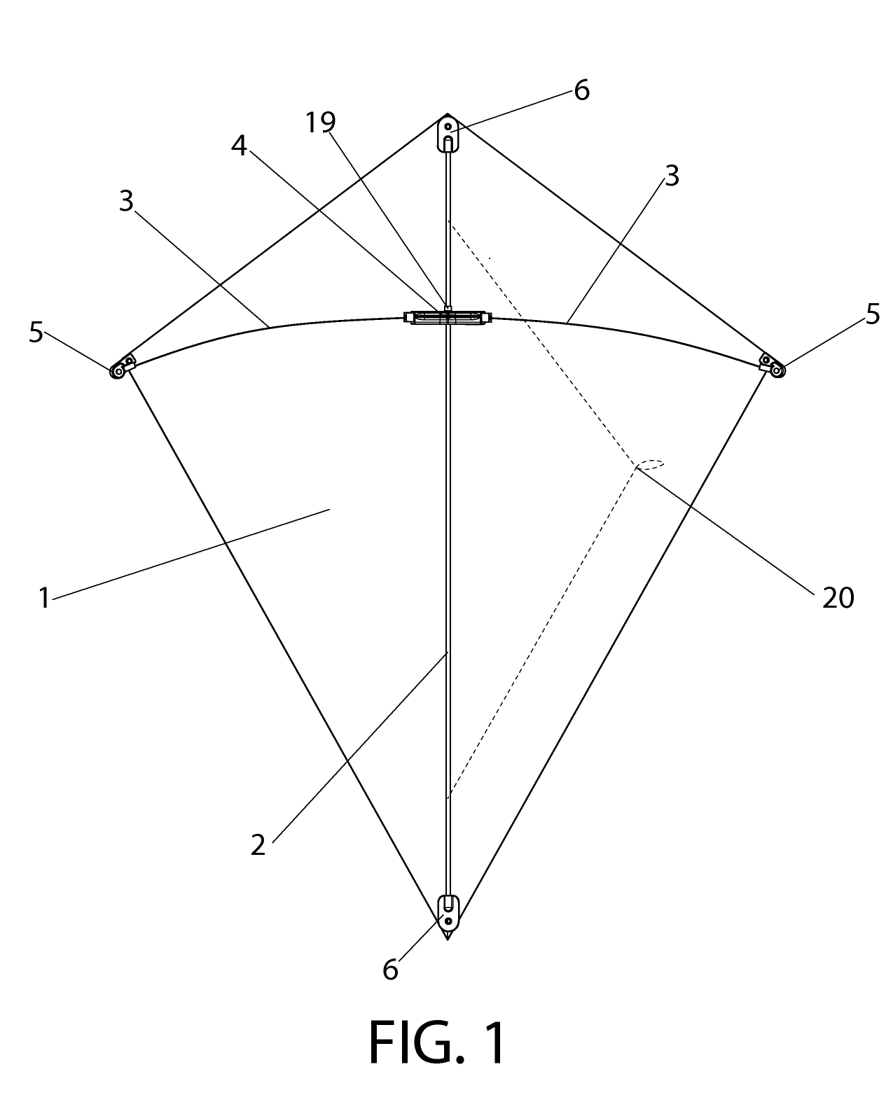

FIG. 2 shows a view of the kite depicted in the previous figure but in the folded position, an operation carried out by means of a single hand

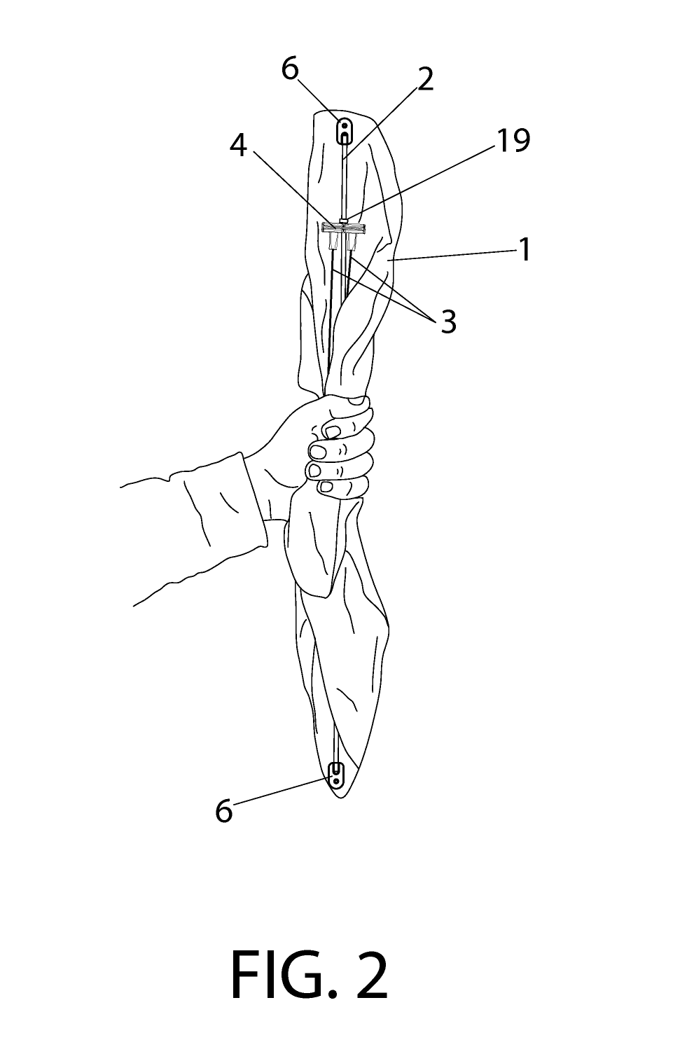

FIG. 3 shows a view corresponding to the start of the extending of the kite depicted in the previous figure.

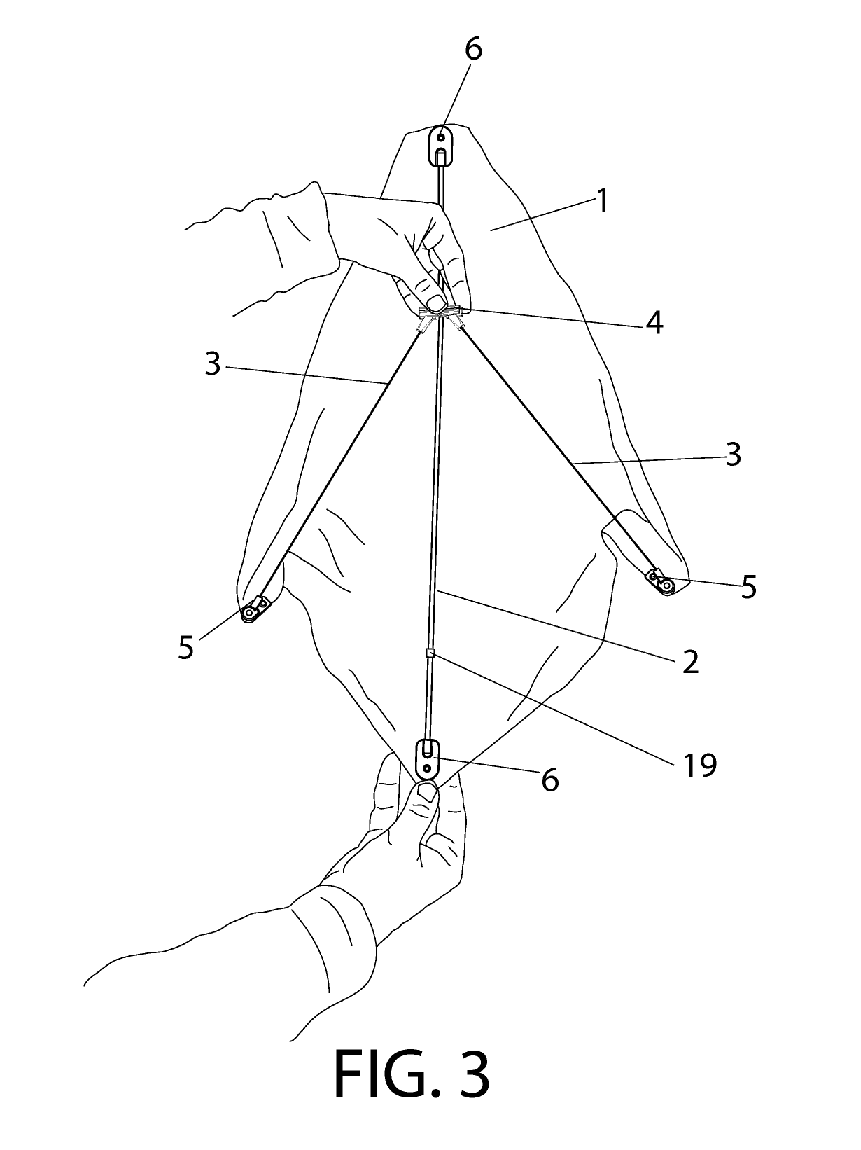

FIG. 4 shows a view similar to the previous one in an intermediate extending stage of the kite.

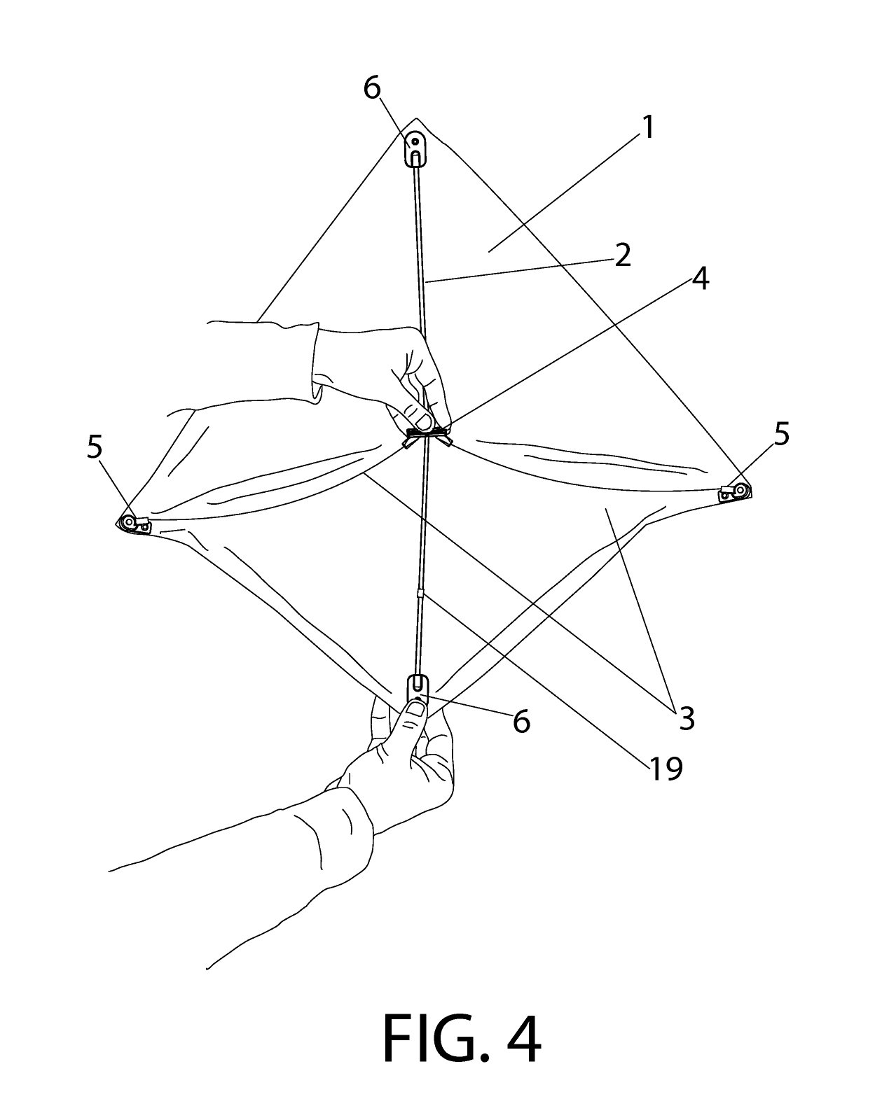

FIG. 5 shows a front view of the kite completely extended from the position depicted in FIG. 4.

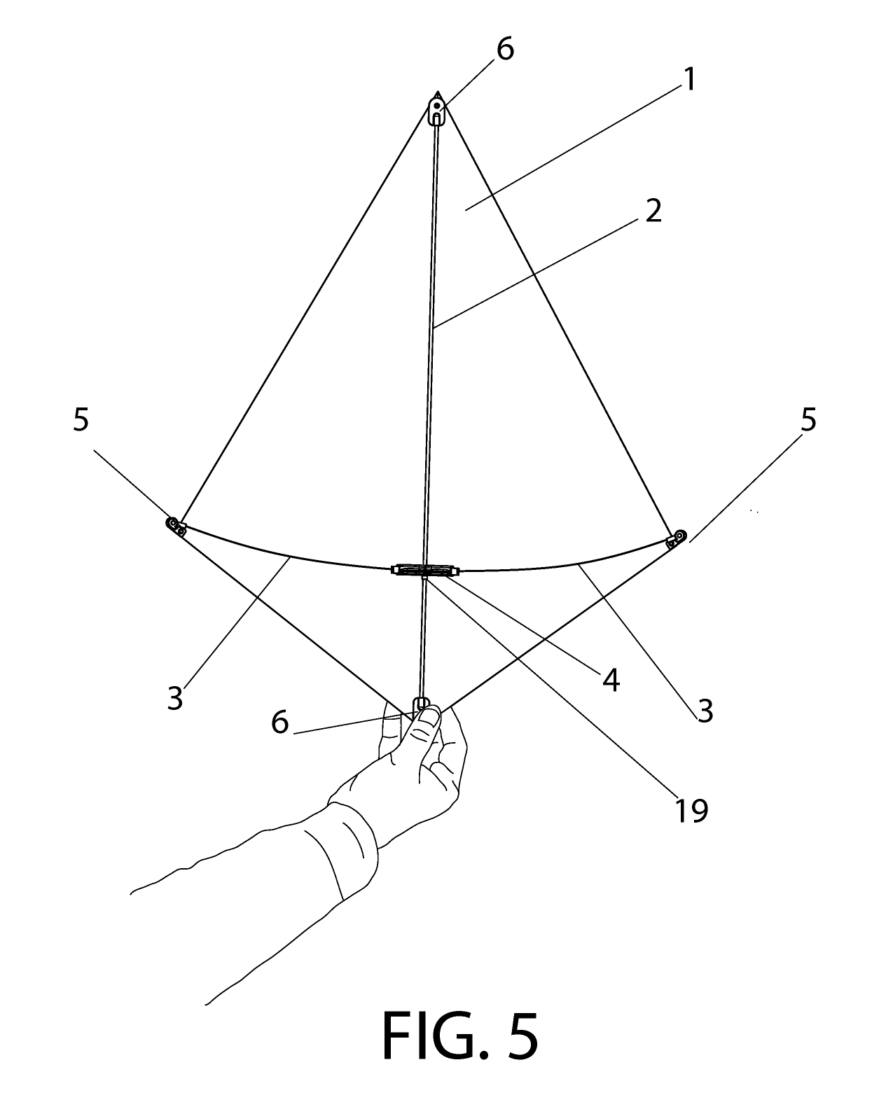

FIG. 6 shows an exploded perspective view of the central connector and the two arms intended to be articulated on same.

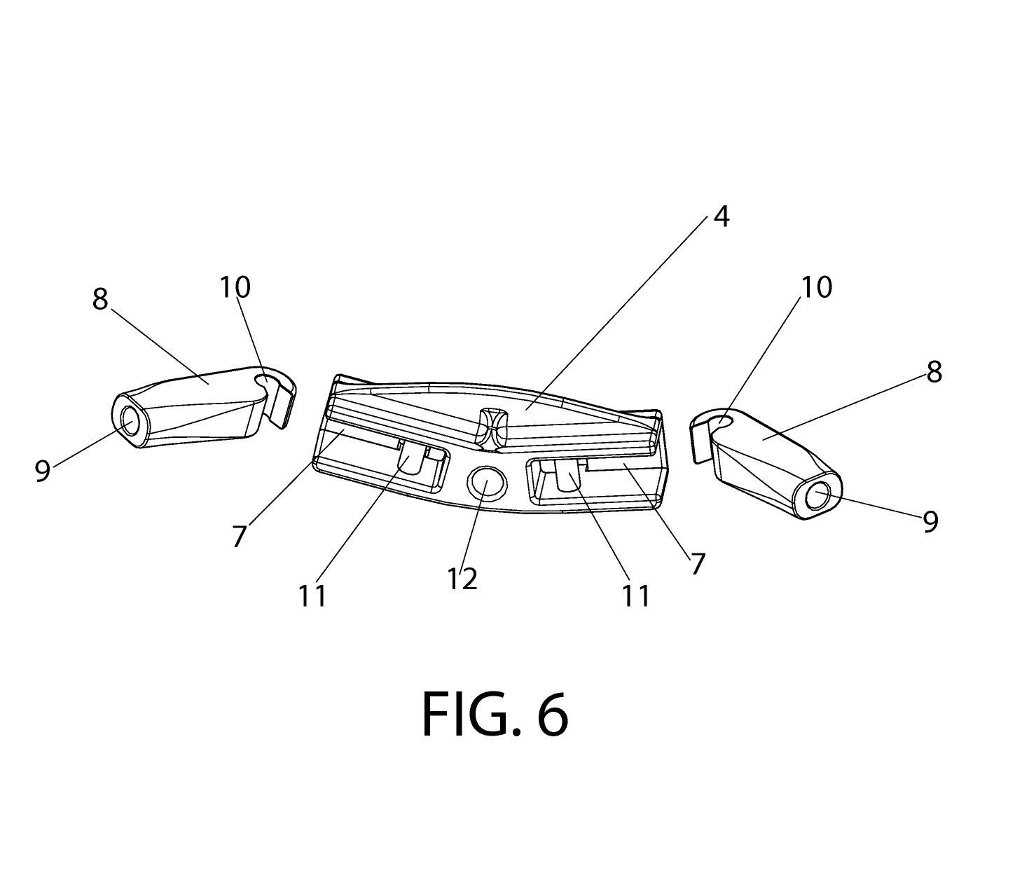

FIG. 7 shows a front view of the central connector with the two arms articulated to same.

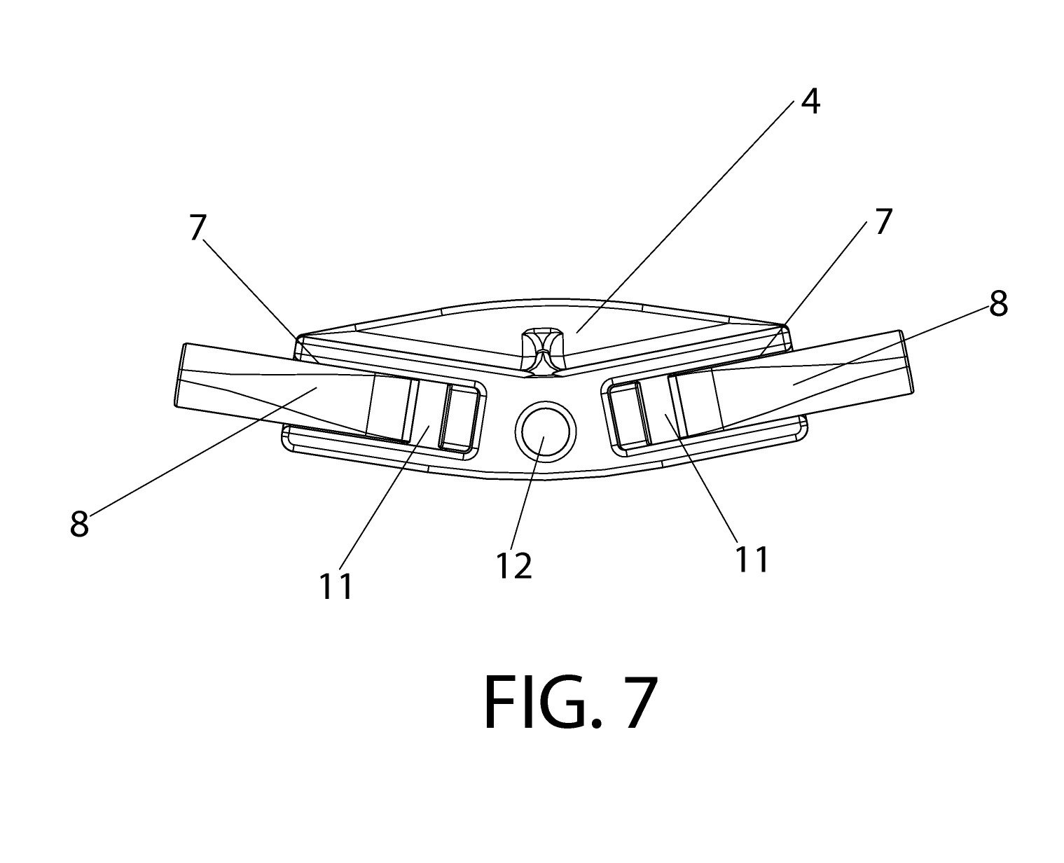

FIG. 8 shows a top view of the assembly depicted in the previous figure, i.e., of the central connector with the two arms assembled to same.

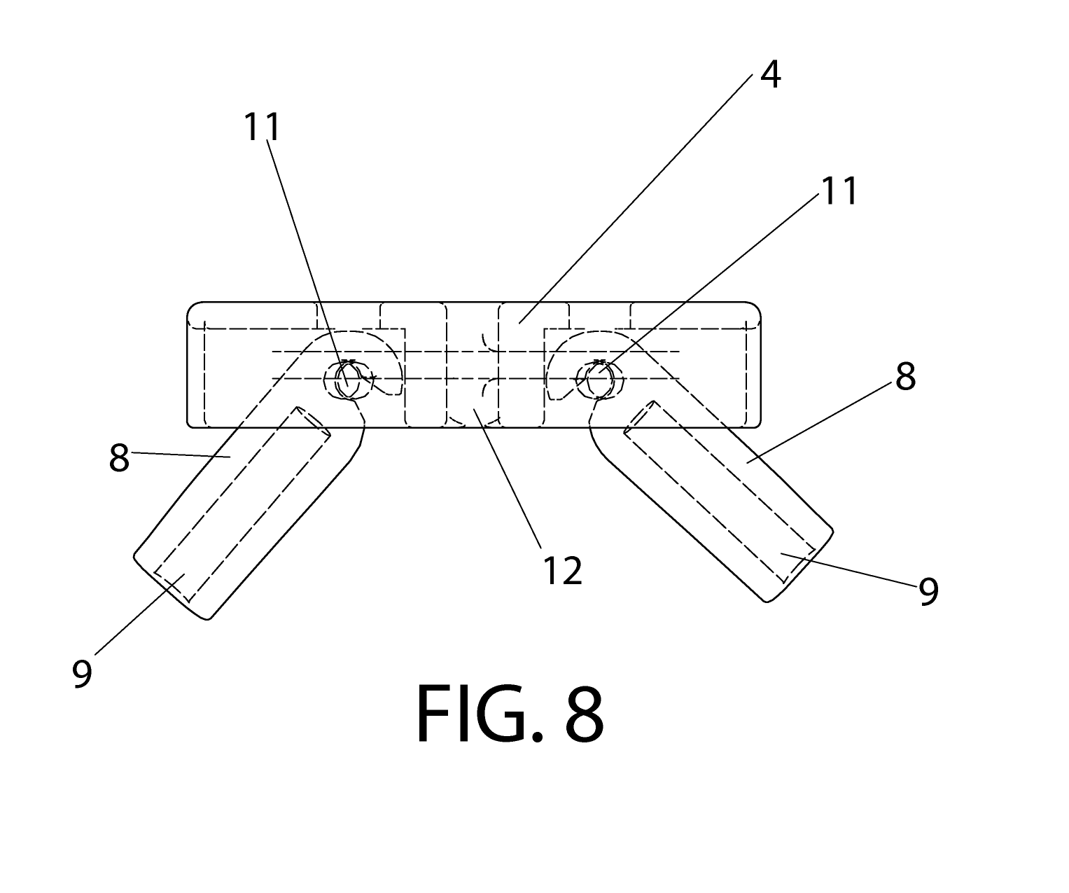

FIG. 9 shows an exploded perspective view of the side connector, the arm intended to be articulated on same and the shaft securing it.

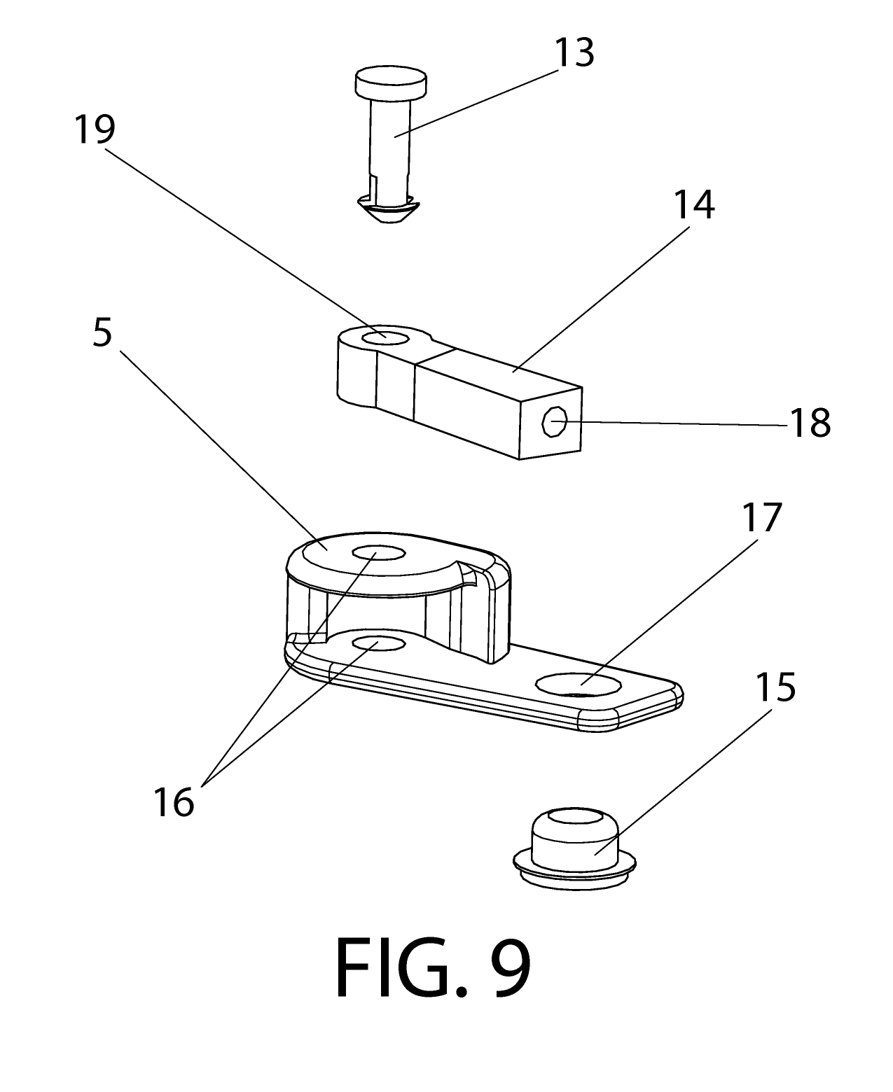

FIG. 10 shows a detailed perspective view of the side connector assembled and attached to the sail.

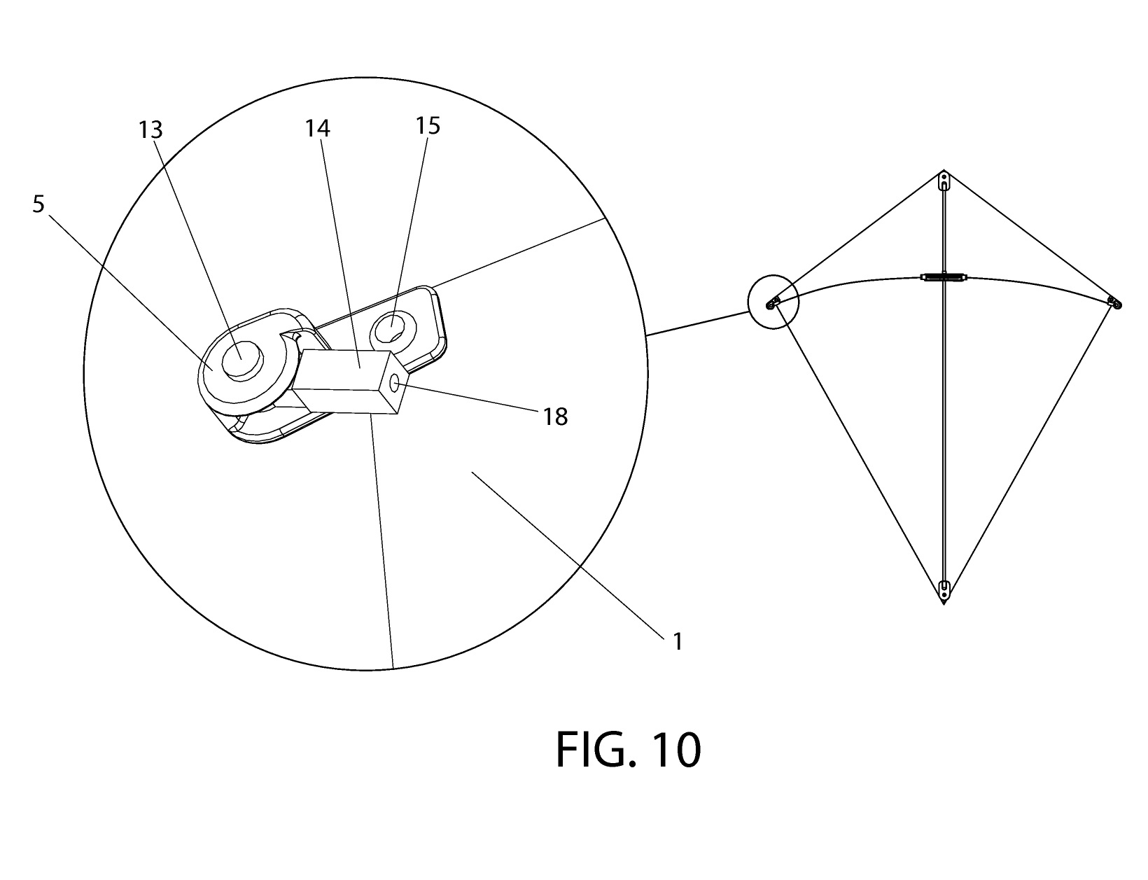

FIG. 11 shows a detailed perspective view of the upper and lower connector assembled and attached to the sail.

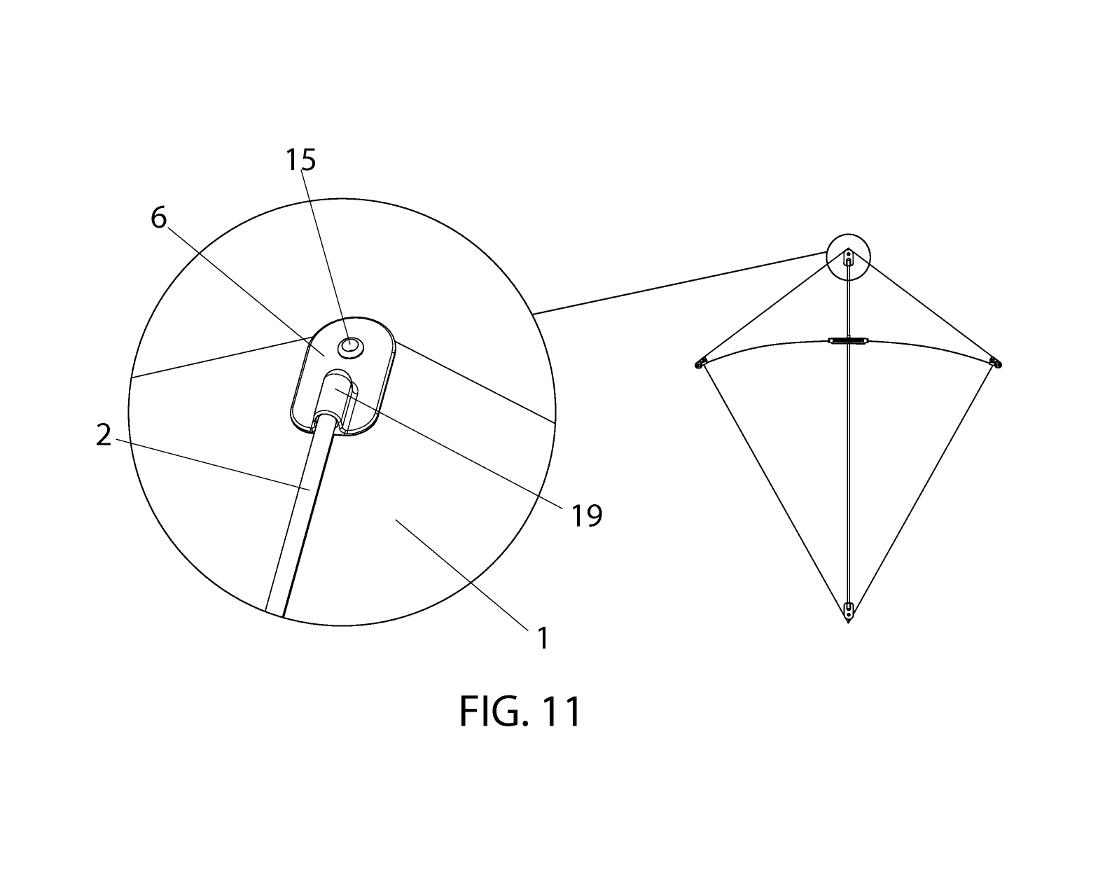

### DETAILED DESCRIPTION OF THE PREFERRED EMBODIMENT(S) OF THE INVENTION

As can be seen in the mentioned drawings, the kite of the invention is made from a laminar body (1) which can be made from plastic or cloth and even other appropriate materials, that laminar body (1) having side connectors (5) with articulated arms (14) in correspondence with the side vertexes of the kite. Said articulated arms (14) are prefixed to the side connector (5) through a shaft (13) which firstly passes through the side connector (5) through 2 axial through holes (16) and lastly through the arm (14) containing in one of its ends a head with an axial through hole (19). The ends of the longitudinal rods (2) are in turn introduced in said arms (14) through an axial blind hole and the free ends of the curvilinear-shaped front-side rods (3) is introduced through another end and they are anchored through another end thereof in a connector (4) assembled in a sliding manner on the central longitudinal rod (2). It also has an upper and lower connector (6) in the vertical vertexes of the kite which connector has a cavity (19) with an axial blind hole to house the central rod (2), said upper and lower connector (6) will be anchored or fixed to the sail by means of a rivet (15) integrally attaching them.

The central connector (4) is provided with laterally projecting channels (7) in which respective arms (8) with a blind hole (9) are positioned to precisely anchor the inner end of the side rods (3), while the other end of those arms (8) form a housing (10) articulated on respective shafts (11) arranged for such purpose in the channels (7) of the connector (4), the latter in turn being provided with a through hole (12) for its assembly and sliding on the central longitudinal rod (2).

Close to the front end of the kite, on the central longitudinal rod (2), a part (19) fixed by means of an adhesive or any other means has been provided, the purpose of which is for blocking the central connector (4) with the articulated side arms (8) in the extended position.

Finally, the kite as a whole will be complemented with the corresponding flight bridle (20) wherein the ends thereof are linked to the central longitudinal rod (2) being unable to move from the previously pre-established location, facilitating the flight of the kite itself.

1. A static kite of seamless articulated assembly, formed from a laminar body of plastic, cloth or similar material which can be folded and extended of a rod based structure, wherein said structure includes a central longitudinal rod and two front-side rods attached at one of their ends on a central connector assembled in a sliding manner on the central longitudinal rod, free ends of the side rods are anchored in respective side connectors in an articulated manner by arms wherein the side rods and a shaft which integrally attaches the side connector to the arm are housed, two front and back ends of the central longitudinal rod being anchored in respective vertical fixed connectors containing a cavity wherein the central rod is housed, both side and vertical connectors being pre-fixed to the kite by means of rivets which integrally attach the side and vertical connectors to the sail with no possibility of rotating or twisting.

2. The static kite of seamless articulated assembly according to claim 1, wherein the central connector has a hole for the passage and sliding assembly sliding on the central longitudinal rod, wherein the central connector laterally has two grooves in which there articulate respective laterally projecting arms and provided with an axial blind hole in which a respective end of each of the side rods locks.

3. The static kite of seamless articulated assembly according to claim 1, wherein articulation of the side arms on the central connector is accomplished by channel formations provided in the arms, which are housed in a gripping or clamping manner on respective shafts arranged in the side channels and the central connector.

4. The static kite of seamless articulated assembly according to claim 1, wherein in an area proximate a front end of the central longitudinal rod, a part fixed by an adhesive has been provided as a locking element for locking the central connector with the articulated side arms in an extended position of the kite assembly.
